(19) United States
(12) Patent Application Publication
(10) Pub. No.: US 2015/0069848 A1
(43) Pub. Date: Mar. 12, 2015

(54) POWER RECEIVING UNIT

(71) Applicant: KABUSHIKI KAISHA TOSHIBA, Tokyo (JP)

(72) Inventors: Kosuke Tashiro, Kawasaki-Shi (JP); Hirotoshi Aizawa, Kawasaki-Shi (JP); Masafumi Otsuka, Yokohama-Shi (JP)

(73) Assignee: KABUSHIKI KAISHA TOSHIBA, Tokyo (JP)

(21) Appl. No.: 14/167,206

(22) Filed: Jan. 29, 2014

(30) Foreign Application Priority Data
Sep. 11, 2013 (JP) 2013-188133

(51) Int. Cl. H02J 5/00

(52) U.S. Cl. CPC H02J 5/005
USPC 307/104

(57) ABSTRACT

A power receiving unit includes a hysteresis comparator, includes a comparison voltage based on an output voltage at an output terminal and a first reference voltage and outputs a comparison result signal responsive to a result of the comparison. The power receiving unit includes a current operational amplifier that receives a converted voltage based on a current flowing through an output transistor and a preset second reference voltage and outputs a current error signal responsive to the difference between the converted voltage and the second reference voltage. The power receiving unit includes a first multiplexer that receives the current error signal and the comparison result signal, selects either of the comparison result signal and the current error signal based on the comparison result signal and outputs the selected signal. The output transistor is controlled based on a first output signal selected by the first multiplexer.

### CROSS-REFERENCE TO RELATED APPLICATION

This application is based upon and claims the benefit of priority from the prior Japanese Patent Application No. 2013-188133, filed on Sep. 11, 2013, the entire contents of which are incorporated herein by reference.

### BACKGROUND

1. Field

Embodiments described herein relate generally to a power receiving unit.

2. Background Art

A conventional power receiving unit receives electric power wirelessly transmitted from a power transmitting circuit, converts the AC electric power into DC electric power in a power receiving circuit, produces a stable voltage from the resulting DC electric power in a step-down regulator and outputs the stable voltage, for example.

### BRIEF DESCRIPTION OF THE DRAWINGS

FIG. 1 is a block diagram showing an example of a configuration of a wireless power supply system 100 according to a first embodiment;

FIG. 2 is a diagram showing an example of the hysteresis characteristic of the hysteresis comparator “HP” shown in FIG. 1;

FIG. 3 is a waveform diagram showing examples of operational waveforms involved with the power receiving unit “RX” shown in FIG. 1;

FIG. 4 is a circuit diagram showing an example of a configuration of a wireless power supply system 200 according to a second embodiment;

FIG. 5 is a waveform diagram showing examples of operational waveforms involved with the power receiving unit “RX” shown in FIG. 4; and

FIG. 6 is a circuit diagram showing an example of a configuration of a wireless power supply system 300 according to a third embodiment.

### DETAILED DESCRIPTION

A power receiving unit, according to an embodiment, receives electric power transmitted from a power transmitting unit by wireless power supply. The power receiving unit includes an output terminal at which an output voltage is output and to which a load is connected. The power receiving unit includes a power receiving circuit that receives the electric power transmitted from the power transmitting unit by wireless power supply, rectifies a received alternating-current power into a direct-current voltage and outputs the rectified voltage from an output part. The power receiving unit includes an output transistor connected between the output part of the power receiving circuit and the output terminal. The power receiving unit includes a hysteresis comparator that has a hysteresis characteristic, compares a comparison voltage based on the output voltage at the output terminal and a first reference voltage and outputs a comparison result signal responsive to a result of the comparison. The output transistor is controlled based on the comparison result signal.

In the following, embodiments will be described with reference to the drawings.

### First Embodiment

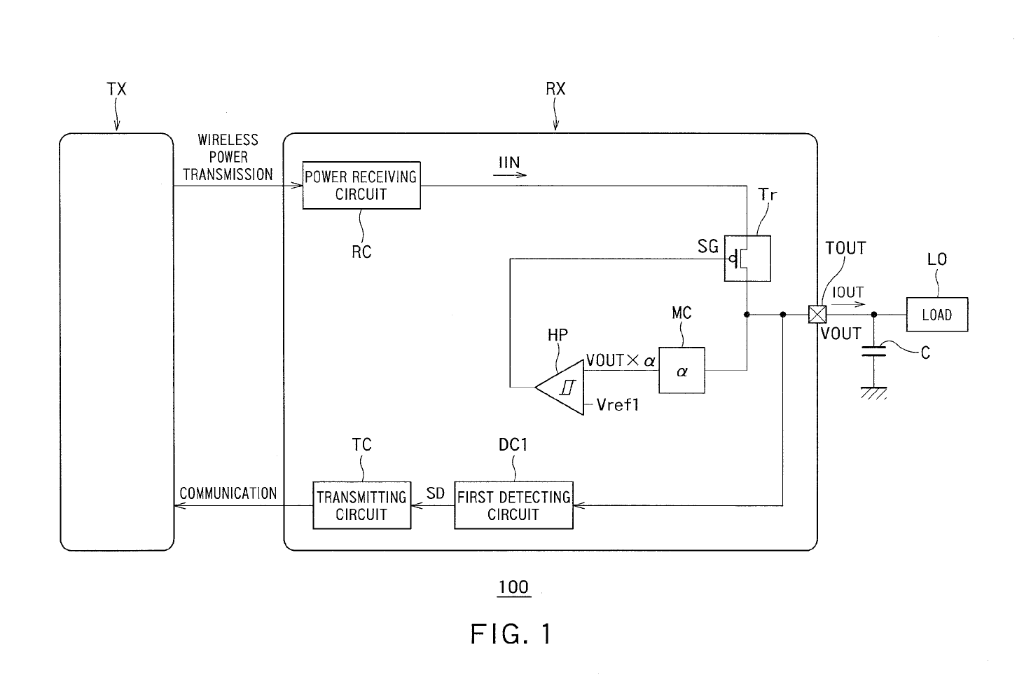

FIG. 1 is a block diagram showing an example of a configuration of a wireless power supply system 100 according to a first embodiment.

In FIG. 1, a power transmitting unit “TX” is configured to transmit electric power. The power transmitting unit “TX” is a charger for a mobile device, such as a smart phone and a tablet PC, for example.

A power receiving unit “RX” receives the electric power output from the power transmitting unit “TX”. The power receiving unit “RX” is an IC that supplies electric power to a charging IC. In this case, a load “LO” is a charging IC for a battery. The power receiving unit “RX” may be a mobile device, such as a battery, a smart phone incorporating a battery and a tablet PC, or a battery charging device to be connected to such a device. Furthermore, the power receiving unit “RX” can be any unit that receives electric power output from an associated power transmitting unit, such as a rechargeable electric automobile, a household appliance and a product for underwater application.

Power transmission from the power transmitting unit “TX” to the power receiving unit “RX” is achieved by electromagnetically coupling a power transmitting coil (not shown) provided in the power transmitting unit “TX” and a power receiving coil (not shown) provided in the power receiving unit “RX” to form a power transmission transformer. In this way, non-contact power transmission can be achieved.

As described above, the power receiving unit “RX” receives electric power transmitted from the power transmitting unit “TX” by wireless power supply, regulates a direct-current voltage generated by a power receiving circuit “RC” to generate a constant voltage (output voltage “VOUT”) and outputs the constant voltage to the load “LO”.

As shown in FIG. 1, the power receiving unit “RX” includes an output terminal “TOUT”, the power receiving circuit “RC”, an output transistor “Tr”, a multiplying circuit “MC”, a hysteresis comparator “HP”, a first detecting circuit “DC1” and a transmitting circuit “TC”.

The output voltage “VOUT” (output current “IOUT”) is output at the output terminal “TOUT”, and the load “LO” is connected to the output terminal “TOUT”. A smoothing capacitor “C” is connected between the output terminal “TOUT” and a ground.

The power receiving circuit “RC” receives electric power transmitted from the power transmitting unit “TX” by wireless power supply, rectifies the received alternating-current power and outputs the resulting rectified direct-current voltage at an output part thereof.

The output transistor “Tr” is connected between the output part of the power receiving circuit “RC” and the output terminal “TOUT”.

As shown in FIG. 1, the output transistor “Tr” is a pMOS transistor connected to the output part of the power receiving circuit “RC” at a source thereof and to the output terminal “TOUT” at a drain thereof and receives a gate signal “SG” (comparison result signal “B1”) at a gate thereof, for example. As an alternative, the output transistor “Tr” may be an nMOS transistor, a PNP type bipolar transistor or an NPN type bipolar transistor, for example.

The multiplying circuit “MC” multiplies the output voltage “VOUT” at the output terminal “TOUT” by a preset multiplier a and outputs the product (VOUT×α) as a comparison voltage. That is, the comparison voltage VOUT×α is a voltage based on the output voltage “VOUT” at the output terminal “TOUT”. The multiplier a is a value equal to or smaller than 1, for example.

The hysteresis comparator “HP” is a common comparator with a hysteresis and has a hysteresis characteristic.

The hysteresis comparator “HP” compares the comparison voltage VOUT×α based on the output voltage “VOUT” at the output terminal “TOUT” with a first reference voltage “Vref1”, and outputs the comparison result signal “B1” (gate voltage) responsive to a result of the comparison.

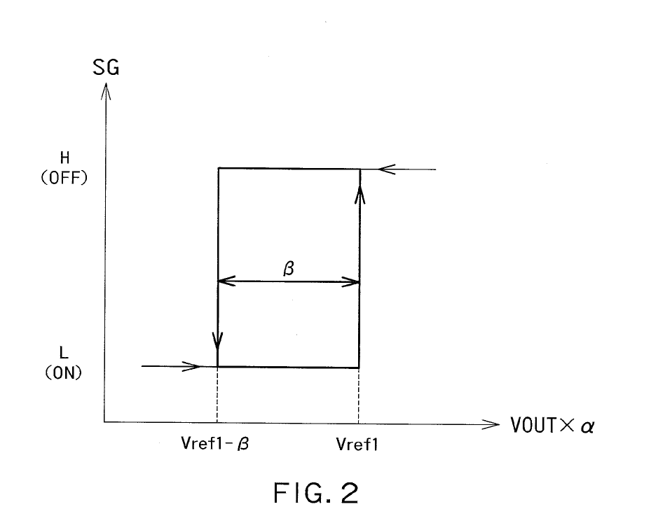

FIG. 2 is a diagram showing an example of the hysteresis characteristic of the hysteresis comparator “HP” shown in FIG. 1.

As shown in FIG. 2, the hysteresis comparator “HP” outputs the comparison result signal “B1” (at a “Low” level) that prescribes a first state in which the output transistor “Tr” is turned on in a case where the comparison voltage VOUT×α is smaller than a first value (Vref1−β) obtained by subtracting a hysteresis value β from the first reference voltage “Vref1”. The hysteresis comparator “HP” also outputs the comparison result signal “B1” (at the “Low” level) that prescribes the first state in which the output transistor “Tr” is turned on in a case where the comparison voltage VOUT×α transitions from the first value (Vref1−β) to the first reference voltage “Vref1”.

That is, in a state where the output transistor “Tr” is in an off state, if the comparison voltage VOUT×α is smaller than a voltage value that is the first reference voltage “Vref1” minus the hysteresis value β, the output transistor “Tr” is turned on. On the other hand, in the state where the output transistor “Tr” is in the off state, if the comparison voltage VOUT×α is equal to or higher than the voltage value that is the first reference voltage “Vref1” minus the hysteresis value β, the output transistor “Tr” is kept in the off state.

On the other hand, as shown in FIG. 2, the hysteresis comparator “HP” outputs the comparison result signal “B1” (at a “High” level) that prescribes a second state in which the output transistor “Tr” is turned off in a case where the comparison voltage VOUT×α is equal to or higher than the first reference voltage “Vref1”. The hysteresis comparator “HP” also outputs the comparison result signal “B1” (at the “High” level) that prescribes the second state in which the output transistor “Tr” is turned off in a case where the comparison voltage VOUT×α transitions from the first reference voltage “Vref1” to the first value (Vref1−β).

In a state where the output transistor “Tr” is in an on state, the output transistor “Tr” is kept in the on state if the output voltage “VOUT” is smaller than the first reference voltage “Vref1”, and is turned off if the output voltage “VOUT” is equal to or higher than the first reference voltage “Vref1”.

The operation of the hysteresis comparator “HP” described above ensures that the output transistor “Tr” operates in a saturation region (on state) in response to the comparison result signal “B1” that prescribes the first state described above, and is turned off in response to the comparison result signal “B1” that prescribes the second state described above. The output voltage “VOUT” is then controlled to fall within a range between the first reference voltage “Vref1” divided by the multiplier a and the first value (Vref1−β) divided by the multiplier a.

That is, the output transistor “Tr” operates under a pulse width modulation (PWM) control so as to be repeatedly turned on and off. As a result, the on-resistance of the output transistor “Tr” through which a current is flowing can be reduced.

The first detecting circuit “DC1” detects an output power output at the output terminal “TOUT” and outputs a first detection signal “SD” based on a result of the detection.

Based on the first detection signal “SD”, the transmitting circuit “TC” transmits a signal containing information about the output power to the power transmitting unit “TX” by wireless communication.

In this way, the power receiving unit “RX” transmits a signal to control the output power, for example, from the transmitting circuit “TC” to the power transmitting unit “TX”. The power transmitting unit “TX” then obtains information based on the output current “IOUT” from the signal received at the power transmitting coil (not shown) by envelope detection, for example.

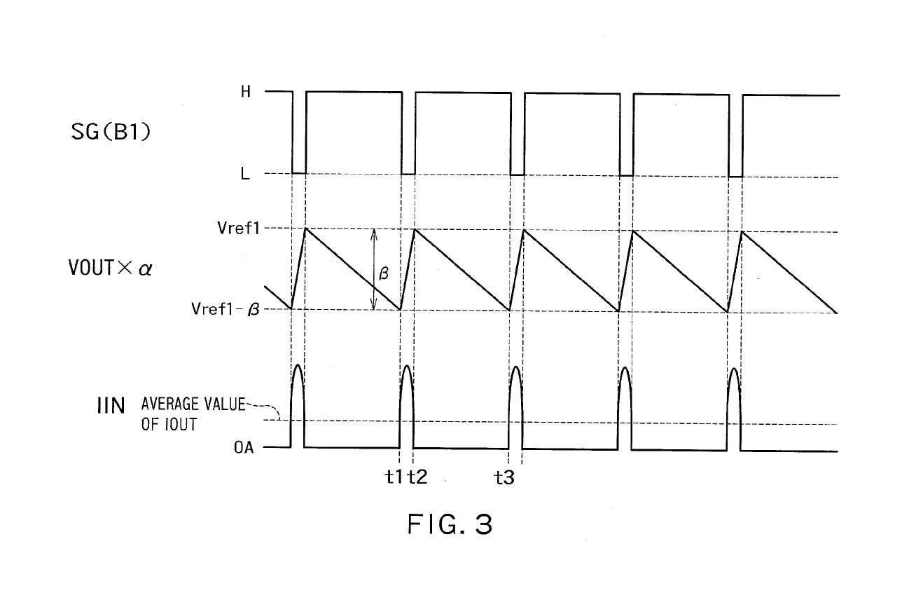

Next, an example of an operation of the power receiving unit “RX” configured as described above will be described. FIG. 3 is a waveform diagram showing examples of operational waveforms involved with the power receiving unit “RX” shown in FIG. 1.

For example, as shown in FIG. 3, in a period from a time “t1” to a time “t2”, if the comparison voltage VOUT×α transitions from the first value (Vref1−β) to the first reference voltage “Vref1”, the hysteresis comparator “HP” outputs the comparison result signal “B1” (at the “Low” level) that prescribes the first state in which the output transistor “Tr” is turned on.

In response to the comparison result signal “B1” (gate signal “SG”) that prescribes the first state described above, the output transistor “Tr” operates in the saturation region (on state).

An input current “IIN” then flows, so that the smoothing capacitor “C” is charged, and the output voltage “VOUT” increases. As a result, the comparison voltage VOUT×α increases.

The comparison voltage VOUT×α then reaches the first reference voltage “Vref1” (at the time “t2”).

In a period from the time “t2” to a time “t3”, if the comparison voltage VOUT×α transitions from the first reference voltage “Vref1” to the first value (Vref1−β), the hysteresis comparator “HP” outputs the comparison result signal “B1” (at the “High” level) that prescribes the second state in which the output transistor “Tr” is turned off.

In response to the comparison result signal “B1” (gate signal “SG”) that prescribes the second state described above, the output transistor “Tr” is turned off.

After that, the same operations are repeated.

Since turning on and off of the output transistor “Tr” is controlled as described above in the power receiving unit “RX”, the on-resistance can be minimized when the output current “IOUT” is supplied, and the efficiency of the power receiving unit “RX” is improved.

As described above, the power receiving unit according to this embodiment can be improved in efficiency.

### Second Embodiment

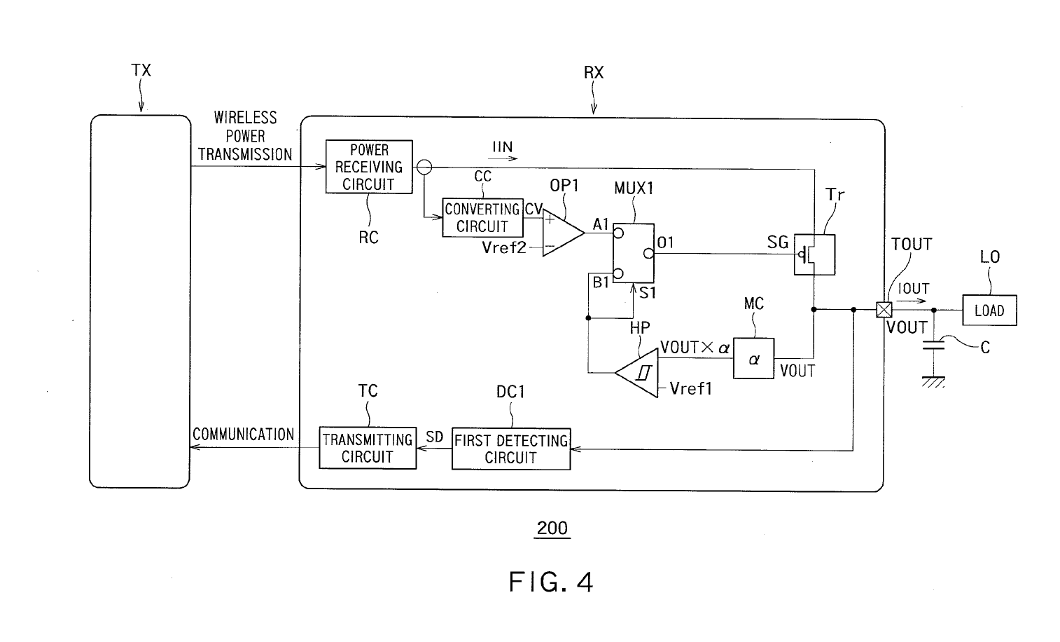

FIG. 4 is a circuit diagram showing an example of a configuration of a wireless power supply system 200 according to a second embodiment. In FIG. 4, the same reference symbols as those in FIG. 1 denote the same components as those according to the first embodiment, and descriptions thereof will be omitted.

As shown in FIG. 4, compared with the first embodiment, the power receiving unit “RX” further includes a current operational amplifier “OP1”, a first multiplexer “MUX1”, and a converting circuit “CC”.

The converting circuit “CC” converts a current correlated with the current flowing through the output transistor “Tr” into a voltage and outputs the voltage as a converted voltage.

As shown in FIG. 4, the converting circuit “CC” detects the input current “IIN”, converts the detected current into a voltage and outputs the resulting voltage as a converted voltage “CV”. As an alternative, the converting circuit “CC” may detect the output current “IOUT”, convert the detected current into a voltage and output the resulting voltage as the converted voltage “CV”.

The current operational amplifier “OP1” receives the converted voltage “CV” based on the current flowing through the output transistor “Tr” and a preset second reference voltage “Vref2”. The current operational amplifier “OP1” then outputs a current error signal “A1” responsive to the difference between the converted voltage “CV” and the second reference voltage “Vref2”. The second reference voltage “Vref2” described above is set to be equal to the converted voltage “CV” at the time when the current flowing through the output transistor “Tr” is equal to a preset target value (set current).

In a case where the converted voltage “CV” is lower than the second reference voltage “Vref2”, the current operational amplifier “OP1” outputs the current error signal “A1” (with a lowered signal level) that prescribes a third state in which the output transistor “Tr” operates in a linear region so as to increase the current flowing therethrough.

On the other hand, in a case where the converted voltage “CV” is equal to or higher than the second reference voltage “Vref2”, the current operational amplifier “OP1” outputs the current error signal “A1” (with a raised signal level) that prescribes a fourth state in which the output transistor “Tr” operates in the linear region so as to decrease the current flowing therethrough.

The first multiplexer “MUX1” receives the current error signal “A1” and the comparison result signal “B1”. Based on the comparison result signal “B1” (selection signal “S1”), the first multiplexer “MUX1” selects either of the comparison result signal “B1” and the current error signal “A1” and outputs the selected signal.

For example, in a case where the comparison result signal “B1” prescribes the first state in which the output transistor “Tr” is turned on, the first multiplexer “MUX1” selects the current error signal “A1” and outputs the signal as a first output signal “O1”.

As a result, the current flowing through the output transistor “Tr” is adjusted so that the converted voltage “CV” and the second reference voltage “Vref2” are equal to each other.

On the other hand, in a case where the comparison result signal “B1” prescribes the second state in which the output transistor “Tr” is turned off, the first multiplexer “MUX1” selects the comparison result signal “B1” and outputs the signal as the first output signal “O1”.

As described above, the first multiplexer “MUX1” selects the current error signal “A1” when the comparison result signal “B1” prescribes that the output transistor “Tr” is turned on, and selects the comparison result signal “B1” when the comparison result signal “B1” prescribes that the output transistor “Tr” is turned off.

The output transistor “Tr” is controlled based on the first output signal “O1” selected and output by the first multiplexer “MUX1”.

The remainder of the configuration of the wireless power supply system 200 is the same as that of the wireless power supply system 100 according to the first embodiment.

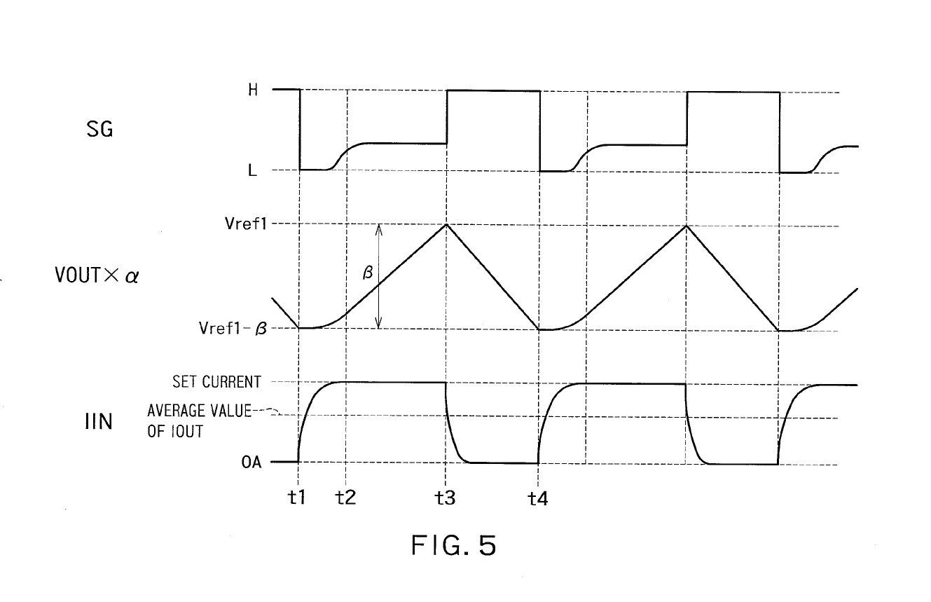

Next, an example of an operation of the power receiving unit “RX” configured as described above will be described. FIG. 5 is a waveform diagram showing examples of operational waveforms involved with the power receiving unit “RX” shown in FIG. 4.

In FIG. 5, in a period from a time “t1” to a time “t2”, the gate signal “SG” is at the “Low” level, and the output transistor “Tr” is completely turned on, as in the period from the time “t1” to the time “t2” in the first embodiment shown in FIG. 3.

At the time “t1”, the output transistor “Tr” is turned on, and a current starts flowing. The current then increases, and when the current reaches the set current (at the time “t2”), the output transistor “Tr” enters into a state where the output transistor “Tr” is controlled so that the amount of the current flowing through the output transistor “Tr” is equal to or smaller than a preset current value (in a period from the time “t2” to a time “t3”). In the period from the time “t2” to the time “t3”, the output transistor “Tr” is controlled according to the current error signal “A1” output from the current operational amplifier “OP1”.

At the time “t3”, the gate signal “SG” supplied to the gate of the output transistor “Tr” assumes such a voltage value that the output current “IOUT” is equal to or smaller than the set current, and the amount of the current flowing through the output transistor “Tr” is limited.

Once the output voltage “VOUT” increases and reaches the first reference voltage “Vref1” (at the time “t3”), the output transistor “Tr” is turned off, and the input current “TIN” decreases to 0 (in a period from the time “t3” to a time “t4”). The operation in the period from the time “t3” to the time “t4” is the same as that in the period from the time “t1” to the time “t2” in the first embodiment described above.

After that, the same operations are repeated.

Since turning on and off of the output transistor “Tr” is controlled as described above in the power receiving unit “RX”, the on-resistance can be minimized when the output current “IOUT” is supplied, and the efficiency of the power receiving unit “RX” is improved.

In addition, addition of the capability of limiting the amount of the current supplied to the output enables suppression of a rush current that occurs when the output transistor “Tr” having been in the off state is turned on.

The remainder of the operation of the power receiving unit “RX” is the same as that according to the first embodiment.

Thus, the power receiving unit according to this embodiment can be improved in efficiency.

### Third Embodiment

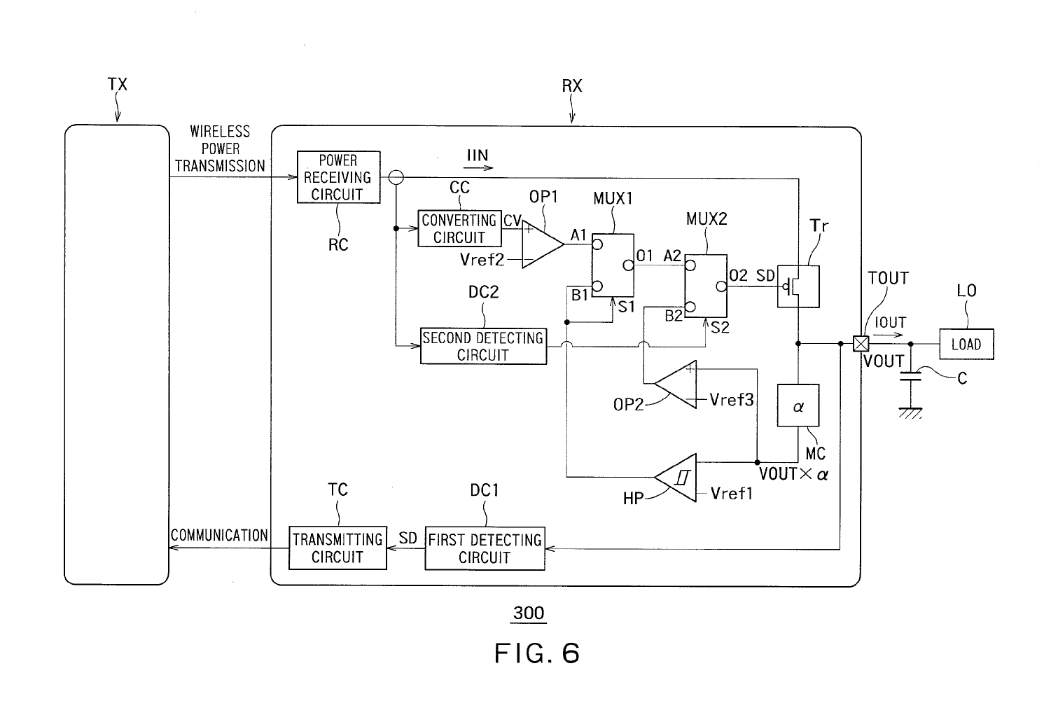

FIG. 6 is a circuit diagram showing an example of a configuration of a wireless power supply system 300 according to a third embodiment. In FIG. 6, the same reference symbols as those in FIG. 4 denote the same components as those according to the second embodiment, and descriptions thereof will be omitted.

As shown in FIG. 6, compared with the second embodiment, the power receiving unit “RX” further includes a second detecting circuit “DC2”, a voltage operational amplifier “OP2”, and a second multiplexer “MUX2”.

The second detecting circuit “DC2” detects a current based on the current flowing through the output transistor “Tr” and outputs a second detection signal “S2” responsive to a result of the detection.

For example, in a case where the second detecting circuit “DC2” detects a fifth state in which the current flowing through the output transistor “Tr” is equal to or higher than a preset current threshold, the second detecting circuit “DC2” outputs the second detection signal “S2” that prescribes the fifth state.

On the other hand, in a case where the second detecting circuit “DC2” detects a sixth state in which the current flowing through the output transistor “Tr” is lower than the current threshold, the second detecting circuit “DC2” outputs the second detection signal “S2” that prescribes the sixth state.

The voltage operational amplifier “OP2” receives the comparison voltage VOUT×α and a preset third reference voltage “Vref3”, and outputs a voltage error signal “B2” responsive to the difference between the comparison voltage VOUT×α and the third reference voltage “Vref3”. The third reference voltage “Vref3” and the first reference voltage “Vref1” are set at different values. For example, the third reference voltage “Vref3” is set at a value smaller than the value of the first reference voltage “Vref1”.

For example, in a case where the comparison voltage VOUT×α is lower than the third reference voltage “Vref3”, the voltage operational amplifier “OP2” outputs the voltage error signal “B2” (with a lowered signal level) that prescribes a seventh state in which the output transistor “Tr” operates so as to increase the current flowing therethrough in a linear region.

On the other hand, in a case where the comparison voltage VOUT×α is equal to or higher than the third reference voltage “Vref3”, the voltage operational amplifier “OP2” outputs the voltage error signal “B2” (with a raised signal level) that prescribes an eighth state in which the output transistor “Tr” operates so as to decrease the current flowing therethrough in the linear region.

The second multiplexer “MUX2” receives the voltage error signal “B2” and the first output signal “O1” (a current error signal “A2”), selects either of the voltage error signal “B2” and the first output signal “O1” based on the second detection signal “S2”, and outputs the selected signal.

For example, in a case where the second detection signal “S2” prescribes the fifth state described above, the second multiplexer “MUX2” selects the first output signal “O1” (the current error signal “A2”) and outputs the signal as a second output signal “O2”.

On the other hand, in a case where the second detection signal “S2” prescribes the sixth state described above, the second multiplexer “MUX2” selects the voltage error signal “B2” and outputs the signal as the second output signal “O2”.

The second output signal “O2” output from the second multiplexer “MUX2” is the gate signal “SG” to be supplied to the gate of the output transistor “Tr”.

That is, according to this embodiment, the output transistor “Tr” is controlled based on the second output signal “O2” selected and output by the second multiplexer “MUX2”.

As described above, the second multiplexer “MUX2” selects the first output signal “O1” when the value of the current flowing through the output transistor “Tr” is equal to or higher than a certain current, and selects the voltage error signal “B2” when the value of the current flowing through the output transistor “Tr” is lower than the certain current.

If the second multiplexer “MUX2” selects the first output signal “O1”, turning on and off of the output transistor “Tr” is controlled with the amount of the current flowing through the output transistor “Tr” limited.

If the second multiplexer “MUX2” selects the voltage error signal “B2”, the amount of the current flowing through the output transistor “Tr” is controlled in an analog manner so that the voltage operational amplifier “OP2” makes the output voltage “VOUT” equal to the third reference voltage “Vref3”.

Since turning on and off of the output transistor “Tr” is controlled as described above in the power receiving unit “RX”, the on-resistance can be minimized when the output current “TOUT” is supplied, and the efficiency of the power receiving unit “RX” is improved.

According to this embodiment, the capability of adjusting the amount of the current flowing through the output transistor “Tr” so that the output voltage “VOUT” is equal to a set voltage is additionally provided, and it is possible to switch between this capability and the capability according to the second embodiment described above depending on the conditions. As a result, both the advantage of a low ripple as with an LDO regulator and the advantage of the improvement in efficiency can be achieved.

As described above, the power receiving unit according to this embodiment can be improved in efficiency.

In the third embodiment, the converting circuit “CC”, the current operational amplifier “OP1” and the first multiplexer “MUX1” can be omitted. In that case, the comparison result signal “B1” output from the hysteresis comparator “HP” is directly input to the second multiplexer “MUX2”. Based on the second detection signal (selection signal “S2”), the second multiplexer “MUX2” then selects either of the voltage error signal “B2” and the comparison result signal “B1”, and outputs the selected signal as the second output signal “O2”. The output transistor “Tr” is controlled based on the second output signal “O2” selected and output by the second multiplexer “MUX2”.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power receiving unit that receives electric power transmitted from a power transmitting unit by wireless power supply, comprising:
an output terminal at which an output voltage is output;
a power receiving circuit that receives the electric power transmitted from the power transmitting unit by wireless power supply, rectifies a received alternating-current power into a direct-current voltage and outputs the rectified voltage from an output part;
an output transistor connected between the output part of the power receiving circuit and the output terminal; and
a hysteresis comparator that has a hysteresis characteristic, compares a comparison voltage based on the output voltage at the output terminal and a first reference voltage and outputs a comparison result signal responsive to a result of the comparison,
wherein the output transistor is controlled based on the comparison result signal.

2. The power receiving unit according to claim 1, further comprising:
a current operational amplifier that receives a converted voltage based on a current flowing through the output transistor and a preset second reference voltage and outputs a current error signal responsive to a difference between the converted voltage and the second reference voltage; and
a first multiplexer that receives the current error signal and the comparison result signal, selects either of the comparison result signal and the current error signal based on the comparison result signal and outputs a first output signal,
wherein the output transistor is controlled based on the first output signal as substitute for the comparison result signal.

3. The power receiving unit according to claim 1, further comprising:
a first detecting circuit that detects an output power output at the output terminal and outputs a first detection signal based on a result of the detection; and
a transmitting circuit that transmits a signal containing information about the output power to the power transmitting unit by wireless communication based on the first detection signal.

4. The power receiving unit according to claim 1, wherein the hysteresis comparator
outputs the comparison result signal that prescribes a first state in which the output transistor is turned on in a case where the comparison voltage is lower than a first value, which is the first reference voltage minus a hysteresis value, or in a case where the comparison voltage transitions from the first value to the first reference voltage, and
outputs the comparison result signal that prescribes a second state in which the output transistor is turned off in a case where the comparison voltage is equal to or higher than the first reference voltage or in a case where the comparison voltage transitions from the first reference voltage to the first value.

5. The power receiving unit according to claim 4, wherein the output transistor operates in a saturation region in response to the comparison result signal that prescribes the first state.

6. The power receiving unit according to claim 4, wherein the first multiplexer
selects the current error signal and outputs the current error signal as the first output signal in a case where the comparison result signal prescribes the first state, and
selects the comparison result signal and outputs the comparison result signal as the first output signal in a case where the comparison result signal prescribes the second state.

7. The power receiving unit according to claim 2, wherein the current operational amplifier
outputs the current error signal that prescribes a third state in which the output transistor operates in a linear region so as to increase the current flowing therethrough in a case where the converted voltage is lower than the second reference voltage, and
outputs the current error signal that prescribes a fourth state in which the output transistor operates in the linear region so as to decrease the current flowing therethrough in a case where the converted voltage is equal to or higher than the second reference voltage.

8. The power receiving unit according to claim 2, further comprising:
a second detecting circuit that detects a current based on the current flowing through the output transistor and outputs a second detection signal responsive to a result of the detection;
a voltage operational amplifier that receives the comparison voltage and a preset third reference voltage and outputs a voltage error signal responsive to a difference between the comparison voltage and the third reference voltage; and
a second multiplexer that receives the voltage error signal and the first output signal, selects either of the voltage error signal and the first output signal based on the second detection signal and outputs a second output signal,
wherein the output transistor is controlled based on the second output signal as substitute for the first output signal.

9. The power receiving unit according to claim 8, wherein the second detecting circuit
outputs the second detection signal that prescribes a fifth state in a case where the second detecting circuit detects the fifth state in which the current flowing through the output transistor is equal to or higher than a current threshold, and
outputs the second detection signal that prescribes a sixth state in a case where the second detecting circuit detects the sixth state in which the current flowing through the output transistor is lower than the current threshold, and
the second multiplexer
selects the first output signal and outputs the first output signal as the second output signal in a case where the second detection signal prescribes the fifth state, and
selects the voltage error signal and outputs the voltage error signal as the second output signal in a case where the second detection signal prescribes the sixth state.

10. The power receiving unit according to claim 8, wherein the voltage operational amplifier
outputs the voltage error signal that prescribes a seventh state in which the output transistor operates in a linear region so as to increase the current flowing therethrough in a case where the comparison voltage is lower than the third reference voltage, and
outputs the voltage error signal that prescribes an eighth state in which the output transistor operates in the linear region so as to decrease the current flowing therethrough in a case where the comparison voltage is equal to or higher than the third reference voltage.

11. The power receiving unit according to claim 1, further comprising:
a multiplying circuit that multiples the output voltage at the output terminal by a preset multiplier and outputs the resulting product as the comparison voltage.

12. The power receiving unit according to claim 1, wherein a smoothing capacitor is connected between the output terminal and a ground.

13. The power receiving unit according to claim 1, wherein the output transistor is a pMOS transistor.

14. The power receiving unit according to claim 2, further comprising:
a converting circuit that converts a current correlated with the current flowing through the output transistor into a voltage, and outputs the voltage as the converted voltage.

15. The power receiving unit according to claim 14, wherein the converting circuit detects an input current output from the output part, converts the detected current into a voltage and outputs the voltage as the converted voltage.

16. A power receiving unit that receives electric power transmitted from a power transmitting unit by wireless power supply, comprising:
an output terminal at which an output voltage is output;
a power receiving circuit that receives the electric power transmitted from the power transmitting unit by wireless power supply, rectifies a received alternating-current power into a direct-current voltage and outputs the rectified voltage from an output part;
an output transistor connected between the output part of the power receiving circuit and the output terminal;
a hysteresis comparator that has a hysteresis characteristic, compares a comparison voltage based on the output voltage at the output terminal and a first reference voltage and outputs a comparison result signal responsive to a result of the comparison;
a second detecting circuit that detects a current based on the current flowing through the output transistor and outputs a second detection signal responsive to a result of the detection;
a voltage operational amplifier that receives the comparison voltage and a preset third reference voltage, and outputs a voltage error signal responsive to a difference between the comparison voltage and the third reference voltage; and
a multiplexer that selects either of the comparison result signal and the current error signal based on the second detection signal and outputs a output signal;
wherein the output transistor is controlled based on the output signal.

17. The power receiving unit according to claim 16, further comprising:
a first detecting circuit that detects an output power output at the output terminal and outputs a first detection signal based on a result of the detection; and
a transmitting circuit that transmits a signal containing information about the output power to the power transmitting unit by wireless communication based on the first detection signal.

18. The power receiving unit according to claim 16, further comprising:
a multiplying circuit that multiples the output voltage at the output terminal by a preset multiplier and outputs the resulting product as the comparison voltage.

19. The power receiving unit according to claim 16, wherein a smoothing capacitor is connected between the output terminal and a ground.

20. The power receiving unit according to claim 16, wherein the output transistor is a pMOS transistor.
